(19) United States
(12) Patent Application Publication
(10) Pub. No.: US 2007/0164524 A1
(43) Pub. Date: Jul. 19, 2007

(54) UNIT STRUCTURE OF THE CONTAINER

(76) Inventor: Jing-Ru Chen, Tachia Chen (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/307,019

(22) Filed: Jan. 19, 2006

(51) Int. Cl. B62D 39/00

(52) U.S. Cl. 280/33.998

(57) ABSTRACT

The present invention relates to a unit structure of containers, wherein a penetrated hole is formed on every joint of the left wall, right wall, the upper edge of the rear wall of the container and the edge of the upper plane of the container. A female fastening tape is stitched on the upper surface of the penetrated hole and stuck with the male fastening tape which is stitched on the corresponding place. A front wall installed on the edge of the notch of the upper plane is stitched with the upper plane of the container. An adsorptive member is mounted on the front wall to be attracted with the adsorptive member on the lid. The wheels are mounted on the bottom of the lowest container in order to achieve the purpose that the user can move the multi-layer container easily. By such arrangement, the multi-layer container can be formed firmly and the upper plane of the top container is strengthen to bear the weigh from the stuffs.

### BACKGROUND OF THE INVENTION

1. Field of the Invention

The present invention relates to a unit structure of containers, and more particularly to a unit structure for a container which can be superposed to form a firmly multi-layer container wherein the containers are connected with each other by several fastening tapes and upper plane of the top container can bear the weight of stuffs.

2. Description of the Prior Art

The container for collecting stuffs is one necessary article in our life. Except for the wooden or plastic container which is formed fixedly, the conventional container made by canvas which can be dismantled to reduce the volume when it is not used and has support for its four walls when it is expended is one kind of popular containers on the market. Such container can be used flexibly, and it has the advantage for being dismantled so as to reduce the volume and space when it is not used. However, the superposed containers cannot be engaged fixedly with each other so that it is not steady for the containers which are superposed highly, thereby the conventional invention is not convenience. In addition, the conventional container is formed by sailcloth so as to the upper plane of the top container can bear less pressure so that it is easy to be collapse. So the conventional container has the shortcoming of being not able to placing stuff on the upper plane of the top container. The present invention has arisen to mitigate and/or obviate the afore-described disadvantages.

### SUMMARY OF THE INVENTION

The main purpose of this invention is to provide a unit structure of containers which is superposed and connected with each other by several fastening tapes to form a multi-layer container.

Another purpose of this invention relates to a unit structure of containers which the upper plane of the top container can bear the weight of stuffs so that the invention can allow user to use the space on the upper container.

The present invention will become more obvious from the following description:

In order to achieve the purpose of being superposed to form a multi-layer container, a penetrated hole is formed on every joint of the left wall, right wall, the upper edge of the rear wall of the container and the edge of the upper plane of the container. A female fastening tape is stitched on the upper surface of the penetrated hole and stuck with the male fastening tape which is stitched on the corresponding place.

In order to achieve the purpose that the upper surface of the top container can bear the weight from the stuffs, a front wall installed on the edge of the notch of the upper plane is stitched with the upper plane of the container. An adsorptive member is mounted on the front wall to be attracted with the adsorptive member on the lid.

In order to achieve the purpose that the user can move the multi-layer container easily, the wheels are mounted on the bottom of the lowest container.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a unit structure for a container in accordance with the present invention;

FIG. 2 is a perspective view of the unit structure for a container taken along line A-A;

FIG. 3 is an exploded view of the unit structure for a container in accordance with the present invention;

FIG. 4 is an assembly view of the unit structure for a container in accordance with the present invention;

FIG. 5 is a perspective view of a multi-layer container in accordance with the present invention; and

FIG. 6 is a perspective view of the unit structure for a container taken along line B-B.

FIG. 7 is a perspective view of the unit structure for a container in accordance with the other embodiment;

FIG. 8 is an exploded view of the unit structure for a container in accordance with the other embodiment;

FIG. 9 is a perspective view of the unit structure for a container taken along line A-A in accordance with the other embodiment;

FIG. 10 is a perspective view of the unit structure for a container taken along line C-C in accordance with the other embodiment;

FIG. 111 is an assembly view of the unit structure for a container in accordance with the other embodiment;

FIG. 12 is a perspective view of a multi-layer container in accordance with the other embodiment.

### DETAILED DESCRIPTION OF THE PREFERRED EMBODIMENTS

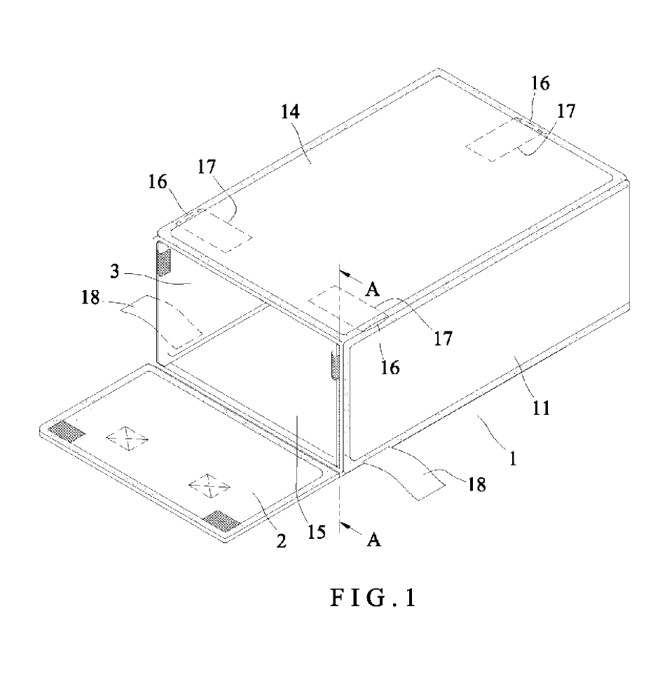

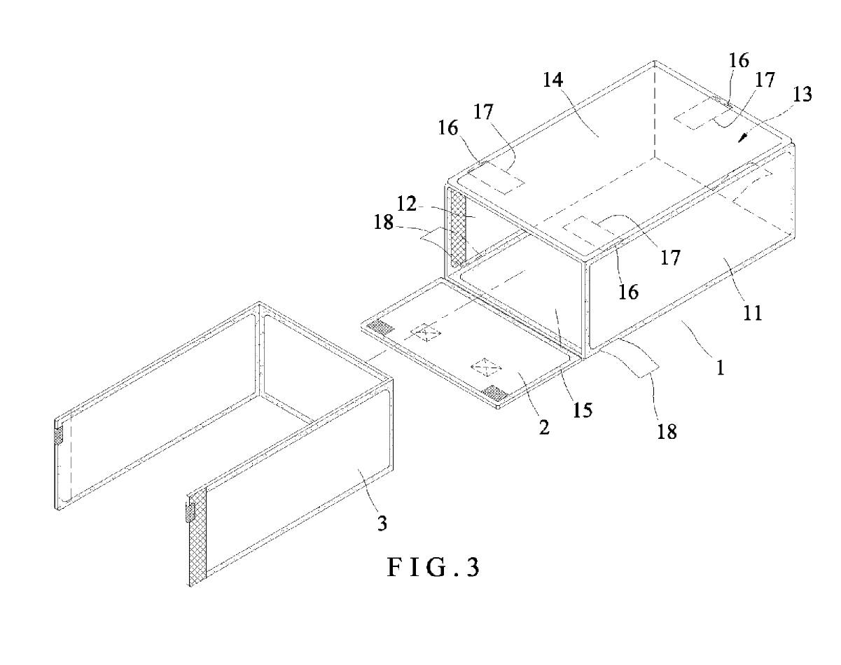

Referring to FIGS. 1-3, a unit structure for a container in accordance with the present invention is comprises a base 1, a lid 2 and a supporting board 3.

The base 1 is a hollow member that is stitched with a left wall 11, a right wall 12, a rear wall 13, an upper plane 14 and a lower plane 15. A penetrated hole 16 is formed in every joint of the left wall 11, right wall 12, the upper edge of the rear wall 13 and the edge of the upper plane 14. The female fastening tapes 17 are stitched on the upper surface of the penetrated hole 16. The male fastening tapes 18 are stitched on the joint of left wall 11, right wall 12, the under edge of the rear wall 13 and the edge of the lower plane 15 by the position corresponding to female fastening tape 17.

The lid 2 is a board with a handle 21 thereof, the lower end of the handle 21 is stitched with the front edge of the lower plane 15 of the base 1.

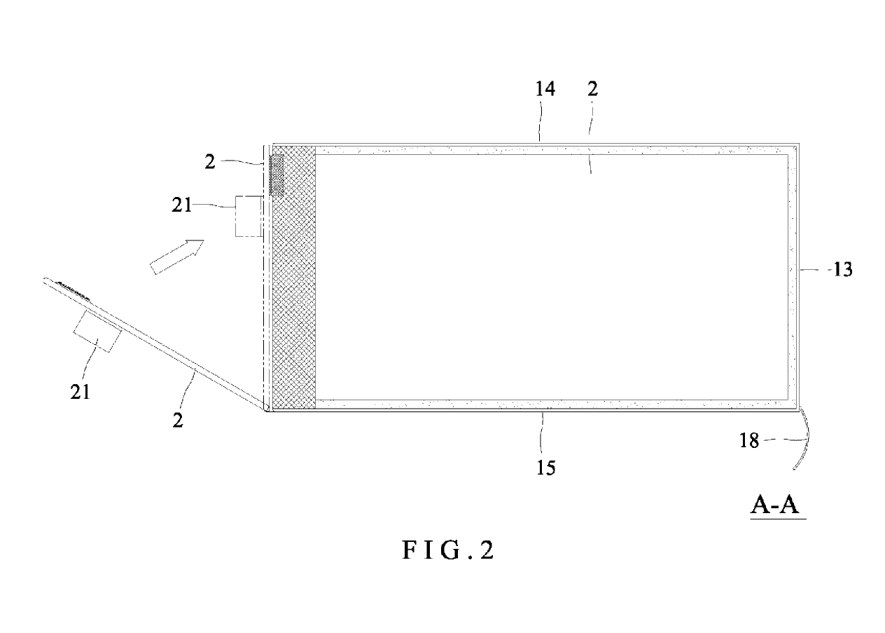

The supporting board 3 can be bended to form a U-shaped member and put into the base 1 as shown in FIG. 2.

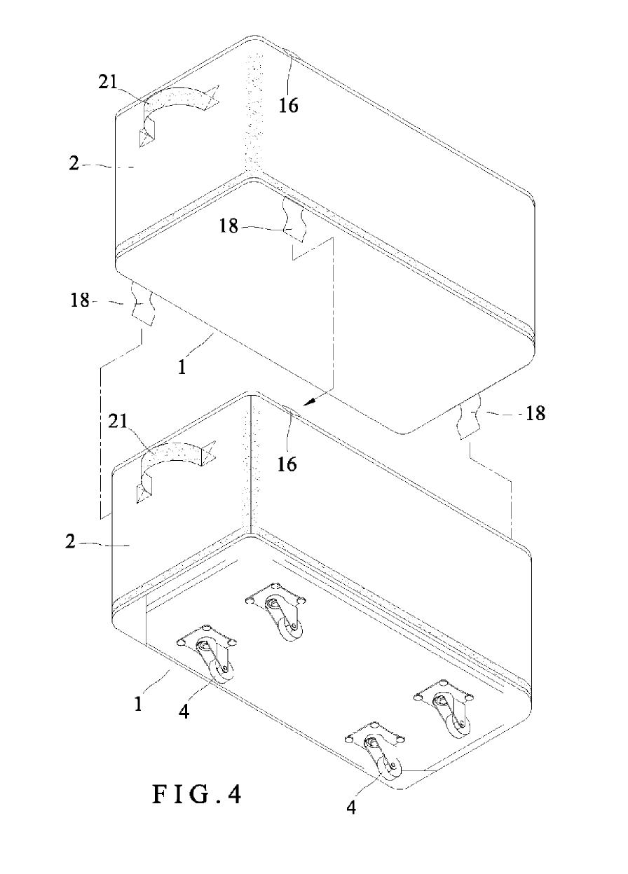

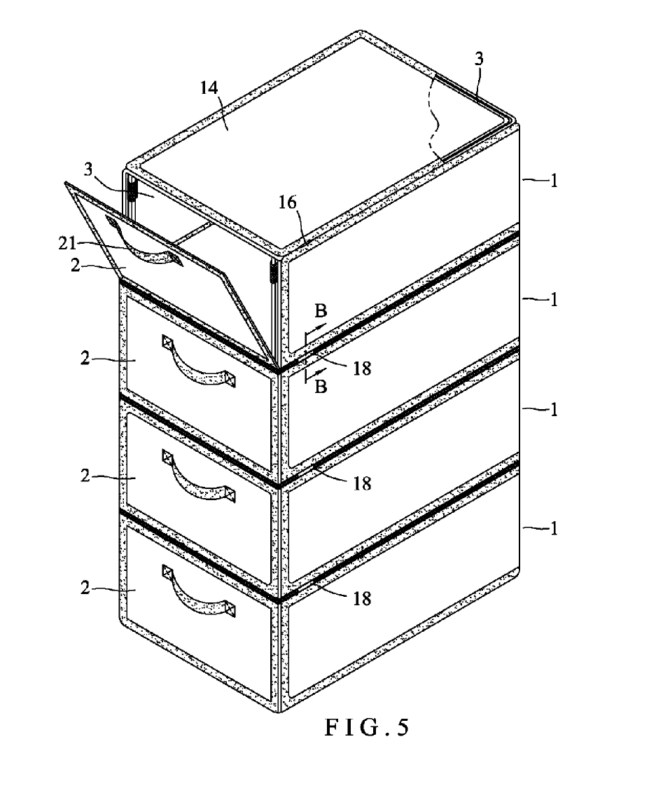

Referring to FIG. 4, several wheels 4 are formed in the bottom of the lowest container in order to facilitate the moving of a multi-layer container.

A multi-layer container as shown in FIGS. 4-6, firstly piercing the male fastening tape 18 through the upper base 1 with penetrated hole 16 of the next base 1, and then engaging the respective male fastening tapes 18 and the female fastening tapes 17 for positioning the superposed containers.

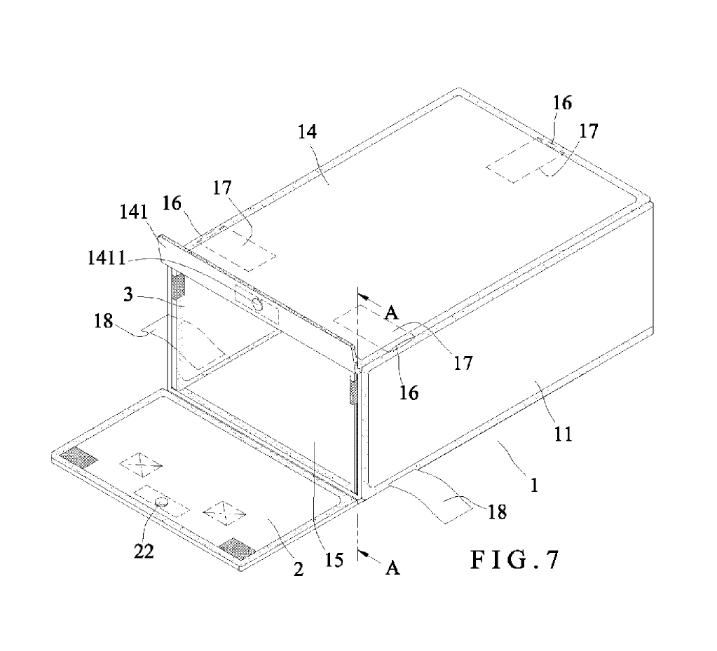

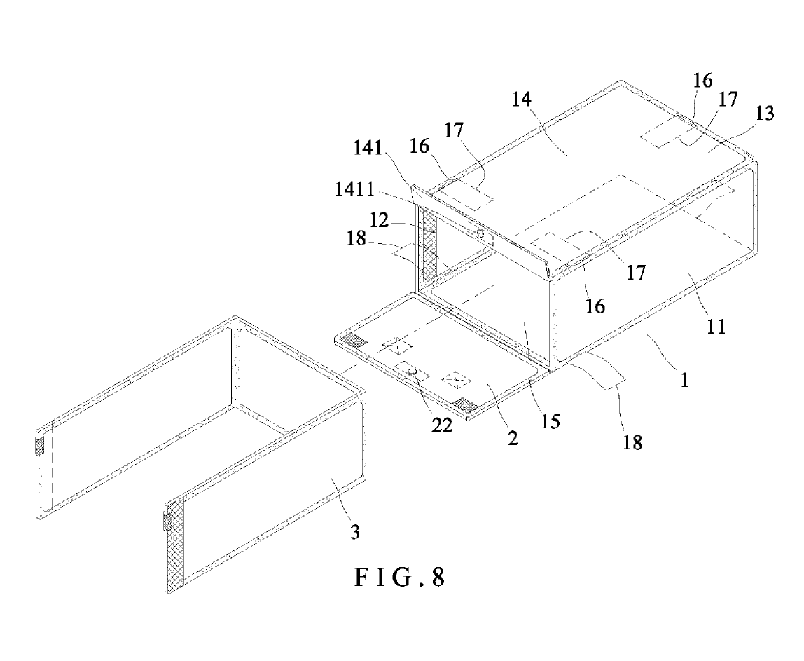

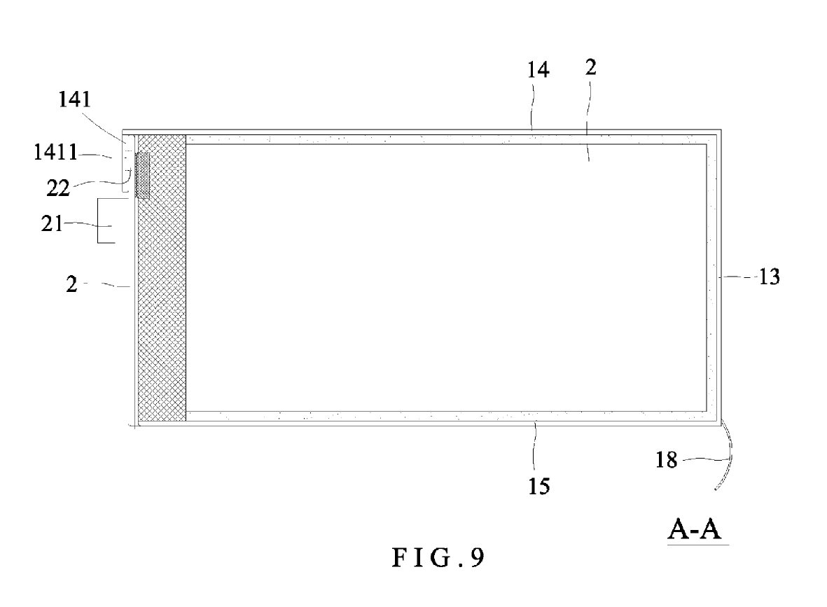

The unit structure as shown in FIGS. 7-9 comprises the base 1 which is a hollow member that is stitched with a left wall 11, a right wall 12, a rear wall 13, an upper plane 14 and a lower plane 15. A penetrated hole 16 is formed in every joint of the left wall 11, right wall 12, the upper edge of the rear wall 13 and the edge of the upper plane 14. The female fastening tapes 17 are stitched on the upper surface of the penetrated hole 16. The male fastening tapes 18 are stitched on the joint of left wall 11, right wall 12, the under edge of the rear wall 13 and the edge of the lower plane 15 by the position corresponding to female fastening tape 17. A front wall 141 installed on the edge of the notch 14 of the upper plane is stitched with the upper plane 14 of the container. An adsorptive member 1411 is mounted on the front wall 141.

A lid 2 which is a board with handle 21, wherein the lower edge is stitched with the front edge of the lower plane 15 of the base 1. The lid is mounted an absorptive member 22 on the position corresponding to the absorptive member 1411 on the front wall 141.

A supporting board is formed as three sections which can be bended as U-shaped. The supporting board can be put into the base 1.

Wheels 4 are mounted on the bottom of the lowest container so that the user can move the multi-layer container easily.

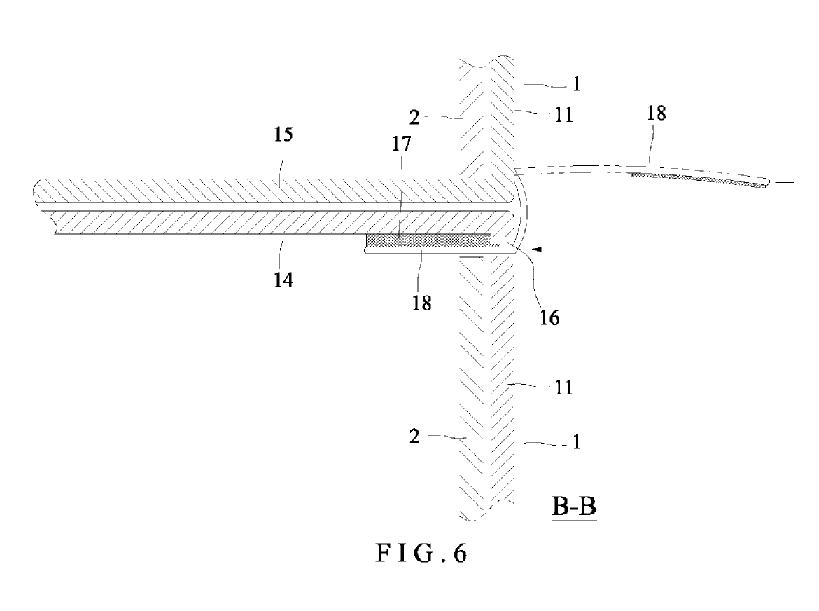

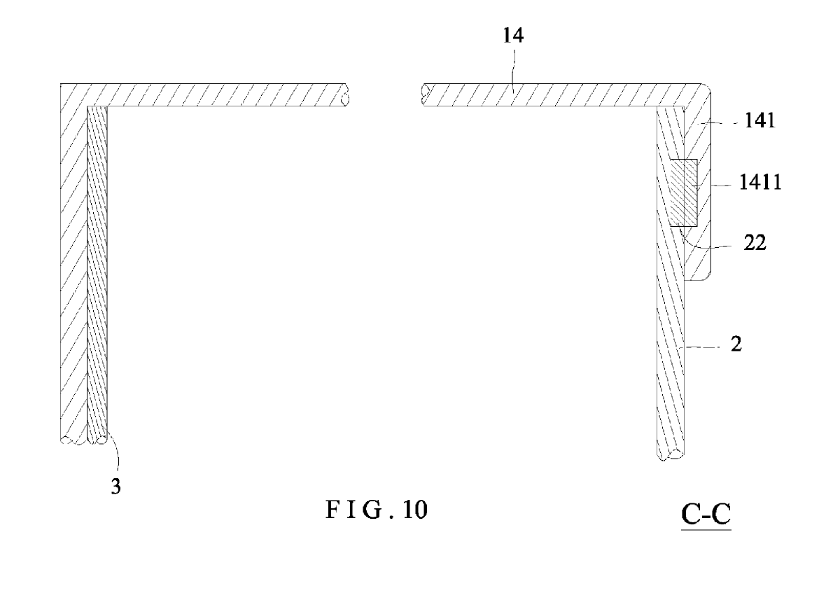

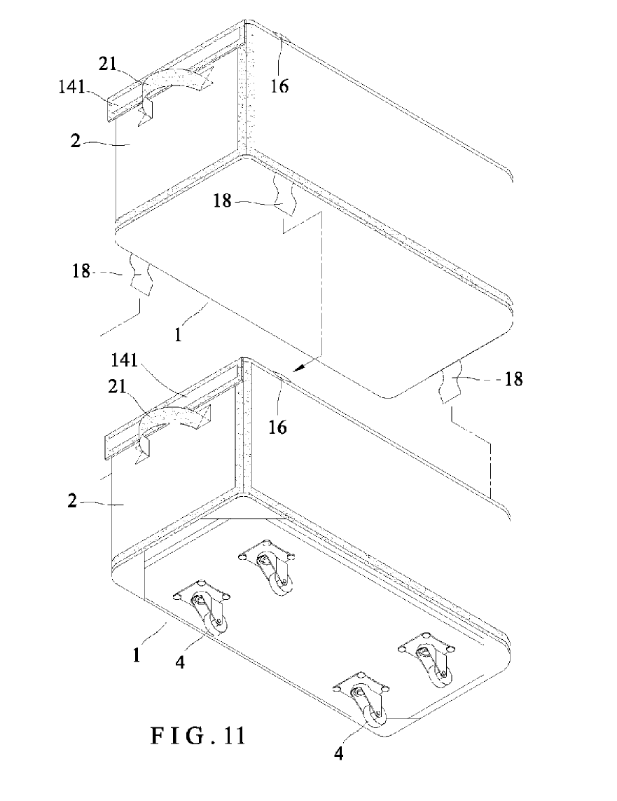

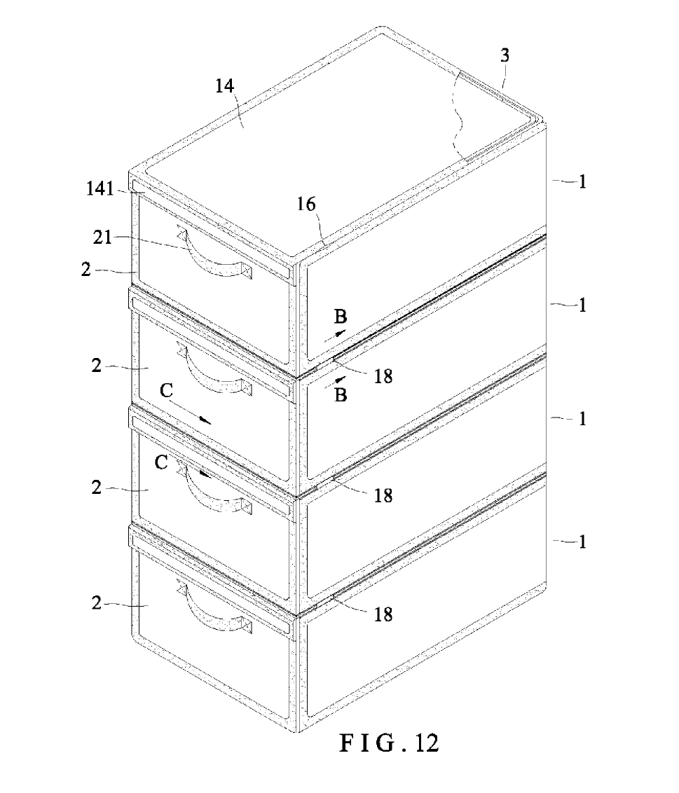

A multi-layer container as shown in FIGS. 6-12, firstly piercing the male fastening tape 18 through the upper base 1 with penetrated hole 16 of the next base 1, and then engaging the respective male fastening tapes 18 and the female fastening tapes 17 for positioning the superposed containers. A front wall 141 installed on the edge of the notch 14 of the upper plane is stitched with the upper plane 14 of the container. An adsorptive member 1411 is mounted on the front wall to be attracted with the adsorptive member 22 on the lid 2 so as to strengthen the upper plane 14. By such arrangement, the user can put stuffs on the upper plane 14 so as to increase the usable space.

What is claimed is:

1. A unit structure for a container comprising a base, a lid and a supporting board; the base including a left wall, a right wall, a rear wall, an upper plane and a lower plane; the lid being a board with a handle thereof, and the lower edge of the lid being stitched on the front edge of the lower plane of the base; and the supporting board with three sections being bended to form a U-shaped member thereof, and the supporting board putting into the base;
on the joint of the upper edge of the left wall, right wall and the rear wall and a edge of the upper surface forming a penetrated hole respectively; and a female fastening tape, which is stitched inside the upper surface of the penetrated hole and; on the joint of the lower edge of the left wall, right wall and the rear wall and a edge of the lower plane forming a male fastening tape respectively, and corresponding to the female fastening tapes forming the male fastening tape;
the male fastening tape of the upper base, which is pierced through the hole of the next base, and then being engaged with the female fastening tapes for engaging the superposed containers.

2. The unit structure for a container comprising a base as claimed in claim 1, wherein several wheels are formed in the bottom of the lowest container in order to facilitate the moving of a multi-layer container.

3. A unit structure for a container comprising a base, a lid and a supporting board; the base including a left wall, a right wall, a rear wall, an upper plane and a lower plane; the lid being a board with a handle thereof, and the lower edge of the lid being stitched on the front edge of the lower plane of the base; and the supporting board with three sections being bended to form a U-shaped member thereof, and the supporting board putting into the base, wherein the improvement is:
on the joint of the upper edge of the left wall, right wall and the rear wall and a edge of the upper surface forms a penetrated hole respectively; and a female fastening tape, which is stitched inside the upper surface of the penetrated hole and; on the joint of the lower edge of the left wall, right wall and the rear wall and a edge of the lower plane forms a male fastening tape respectively, and corresponding to the female fastening tapes forms the male fastening tape, and a front wall mounted on the notch of the upper plane is stitched with the upper plane of the container, and the absorptive member is installed on the front wall to connect with the absorptive member on the lid correspondingly;
the male fastening tape of the upper base which is pierced through the hole of the next base being engaged with the female fastening tapes for engaging the superposed containers so as to strengthen the upper plane so that the user is able to place stuff on the upper plane of the top container.
